(19) United States
(12) Patent Application Publication
(10) Pub. No.: US 2004/0019777 A1
(43) Pub. Date: Jan. 29, 2004

(54) Sharing data using a configuration register

(76) Inventor: Laurance F. Wygant, DuPont, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/426,119

(22) Filed: Apr. 29, 2003

Related U.S. Application Data
(60) Provisional application No. 60/388,923, filed on Jun. 14, 2002.

(51) Int. Cl. G06F 9/00

(52) U.S. Cl. 713/1

(57) ABSTRACT

A first execution thread disabling configuration access to a register that is otherwise dedicated to a storage of a configuration parameter, the first execution thread storing data other than the configuration parameter in the register and a second execution thread accessing the data from the register.

### Cross Reference to Related Applications

This non-provisional United States (U.S.) patent application claims the benefit of U.S. Provisional Application No. 60/388,923, filed on Jun. 14, 2002 by inventor Laurance F. Wygant entitled “Sharing Data using a Configuration Register.”

### BACKGROUND

In a multiprocessor computer system where coordination among processors is necessary during system startup, two or more processors may need to communicate very early during the startup process at a time when key components of the system, such as, for example, a read-write memory system, are not yet functional, and therefore when the support for such communication is limited.

For example, processors may need to communicate at startup because they operate at different frequencies and need to synchronize at a common frequency in order for the system operate correctly. Each processor, in turn, may have multiple frequencies at which it is able to operate. A processor may be designed to operate at a lower frequency in order to conserve power or to reduce heat dissipation, and switch to a higher frequency when it is necessary to use a maximum computing power or when heat dissipation is not a significant constraint. In these situations each of the multiple frequencies at which the processor may operate may need to be synchronized with the corresponding frequencies in all the other processors, and robust methods to perform such synchronization at startup and handle errors while dealing simultaneously with the absence of key system components are necessary.

In order for two concurrently executing threads in two different processors to synchronize internal parameters such as clock frequencies, the two threads need a communication and coordination mechanism. In a shared memory implementation of such a mechanism, a read/write memory area may be used to store coordination variables such as semaphore bits that allow the processors to signal each other when specific events occur, as well as to store the data that is actually communicated between the two threads.

In one embodiment of such a system, a predetermined setting such as a jumper configuration selects one of the several processors in a multiprocessor system to initiate startup. This processor is designated as the bootstrap processor (BSP). The BSP is responsible for starting up the other processors, known as application processors or APs. There may not be any difference between the BSP and APs, though it is necessary that each processor be able to determine whether it is the BSP or an AP once a BSP has been selected. In such systems, data is passed between the APs and the BSP in order for startup to be completed successfully and also for synchronizing the frequency setting of all of the processors including the BSP, in systems where frequency synchronization must be a part of startup.

A complication that arises in the scenarios described is that because such actions must occur early in the startup process, the memory subsystem of the computer may be unavailable for use as a read/write storage area supporting communication between the processors. This may happen because Dynamic Random Access Memory (DRAM) memory subsystems such as Rambus Direct DRAM (RDRAM) or Double-Data-Rate DRAM (DDR RAM), for example, require initialization and set-up before use. Memory initialization, in turn, requires processor action and therefore that the processors in the computer system have already started and are running—and so, processor startup cannot rely on system memory for interprocessor communication.

In another instance, the process of processor startup may itself require that status data be communicated between the BSP and an AP very early in the startup process. On system boot, the BSP needs to discover the processors in the system and determine if they are functional. As stated before, this is a protocol that may be executed very early in system startup and therefore may need a shared storage space other than system RAM to implement data communication between the BSP and AP, if system RAM is not available at the time this protocol executes.

### BRIEF DESCRIPTION OF THE DRAWINGS

FIG. 1 is a high-level block diagram of a multiprocessor computer system in one embodiment of the claimed subject matter.

FIG. 2 is a high-level flowchart of data sharing in one embodiment of the claimed subject matter.

### DETAILED DESCRIPTION

### Multiprocessor Computer System

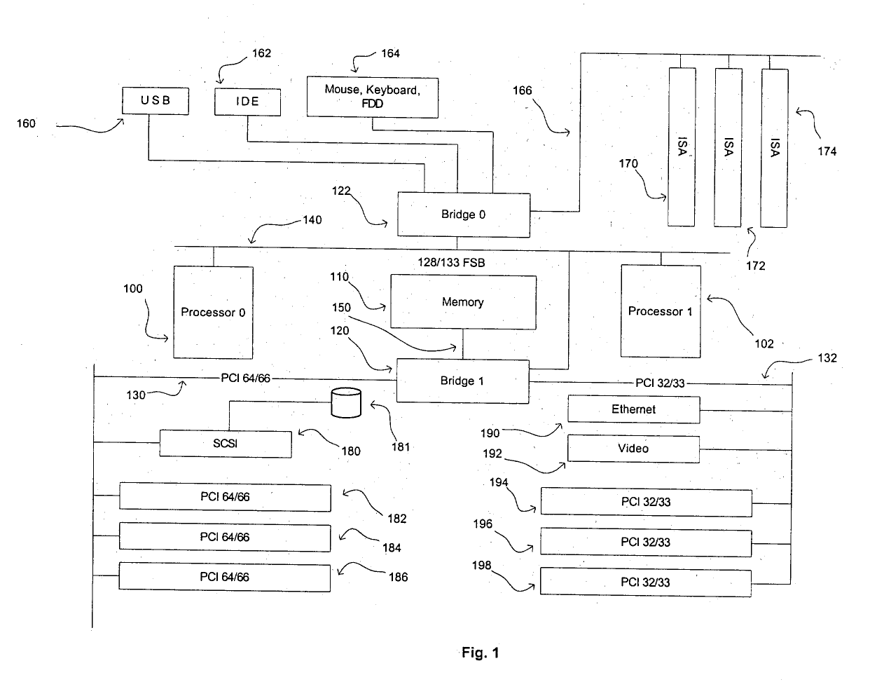

FIG. 1 shows a high-level block diagram of a multiprocessor computer system including an embodiment of the claimed subject matter. This system may in general include several processors, for example the processors 100 and 102 in the figure. One of the processors in this embodiment is designated the bootstrap processor (BSP) at startup, for example, by some deterministic protocol. The other processors are termed application processors (APs). The processors are socketed into a system board. Using board logic and interconnect, the processors are able to access a shared memory subsystem 110 by means of a bus such as a front side bus (FSB) 140, and a memory controller which is part of an integrated device 120. In other embodiments of the claimed subject matter, there may be more than two processors and the bus configuration connecting them to memory and other parts of the system may differ; moreover, the processors may not be part of a general purpose computer system as depicted in FIG. 1, but rather part of any device that uses digital processing capabilities, including digital communication devices such as telephones, or network routing devices; hand held devices such as Personal Digital Assistants (PDAs) and dedicated subsystems included in other digital devices such as a digital television set top box or digital display devices, a digital game console, or a web terminal, among others.

The memory subsystem of the computer system 110 in one embodiment of the claimed subject matter may be one of several types, including for example, an RDRAM, DDR RAM, or Synchronous DRAM (SDRAM) memory subsystem, depending on the specific characteristics of the memory controller 110 and other board logic.

Typically, the processors are also connected to one or more local buses via a bridge. In the embodiment shown in the figure, the integrated device 120 combines the functionality of the memory controller and a bridge that connects the front side bus to a pair of local buses, for example, buses 130 and 132, each of which conforms to the Peripheral Component Interconnect (PCI) Local Bus Specification version 2.3 (PCI bus). In this embodiment, the bridge provides logic and various control functions that allow the processors to address, configure, and exchange data with devices on the bus and the controller itself. In this embodiment, one of the PCI buses, 130, is a 64-bit bus that operates at 66 MHz and the other, 132, a 32-bit bus that operates at 33 MHz. The FSB also connects via a second bridge 122 to a lower speed Industry Standard Architecture (ISA) bus 166, to a Universal Serial Bus (USB) 160, an Integrated Drive Electronics (IDE) bus 162, and low-speed input/output devices such as a Mouse, Keyboard and Floppy Disk Drive 164.

These low-speed devices are specific to the general purpose computer embodiment of the claimed subject matter depicted in FIG. 1 and may differ in other embodiments, or be entirely absent, for example, in a game console or a cellular telephone embodiment of the claimed subject matter.

### PCI Bus

Each of the PCI buses in the embodiment of FIG. 1 supports multiple devices that may be accessed by either of the processors. As shown in the figure, the 64-bit PCI bus is connected to a Small Computer Systems Interface (SCSI) controller to which may be attached one or more mass storage devices 181, and the 32-bit PCI bus to a network adapter 190 and a video and graphics card 192. Other PCI devices may be installed into the computer system using 32-bit PCI slots 194, 196 or 198; or 64-bit PCI slots 182, 184 and 186.

### PCI Configuration Mechanism

The PCI subsystem comprising the bus, controller and PCI devices, allows for system and device configuration by each of the processors. This is implemented by the provision of a pair of PCI registers in the controller termed the PCI Configuration Address Port (PCI-CAP), accessible to each of the processors at I/O addresses 0CF8-0CFB, and the PCI Configuration Data Port, accessible at I/O addresses OCFC-OCFF which allow address to the PCI Configuration Space. The PCI Configuration Space in general stores PCI device and other system related configuration information.

The layout of the 32-bit PCI-CAP is detailed in Table 1. More details are available in the PCI Local Bus Specification version 2.3.

As can be seen from the Table, bit 31 of the PCI-CAP is the enable bit. In a “normal mode” of operation, that is, when the PCI-CAP is used in conformance with the PCI specification, a processor (termed the “host processor”) writes a 32-bit word to the PCI-CAP in compliance with the template in Table 1 and the PCI-CAP is interpreted as indicated in the table.

TABLE 1
Normal Use Allocation of Bit fields in PCI-CAP

| Bits | Purpose |
|---|---|
| 0-1 | Reserved, 0s |
| 2-7 | Address of target double word in target function's configuration |
| | space |
| 8-10 | Address of function number (one of eight) within the target PCI |
| | device |
| 11-15 | Address of target PCI device |
| 16-23 | Address of target PCI bus |
| 24-30 | Reserved, 0s |
| 31 | “enable bit” - 1 to enable configuration |

In this normal use scenario, the device specified by bits 11-15, coupled to the bus specified by bits 16-23, the function specified by bits 8-10 for that device, and the double word specified by bits 2-7 within the configuration space of the function for the device, are selected when the processor writes to the PCI-CAP. The next write to the PCI Configuration Data Port then causes the data written to the Data Port to be loaded into the specified function and double word, thus allowing the host processor to access the various configuration functions and parameters in the PCI device.

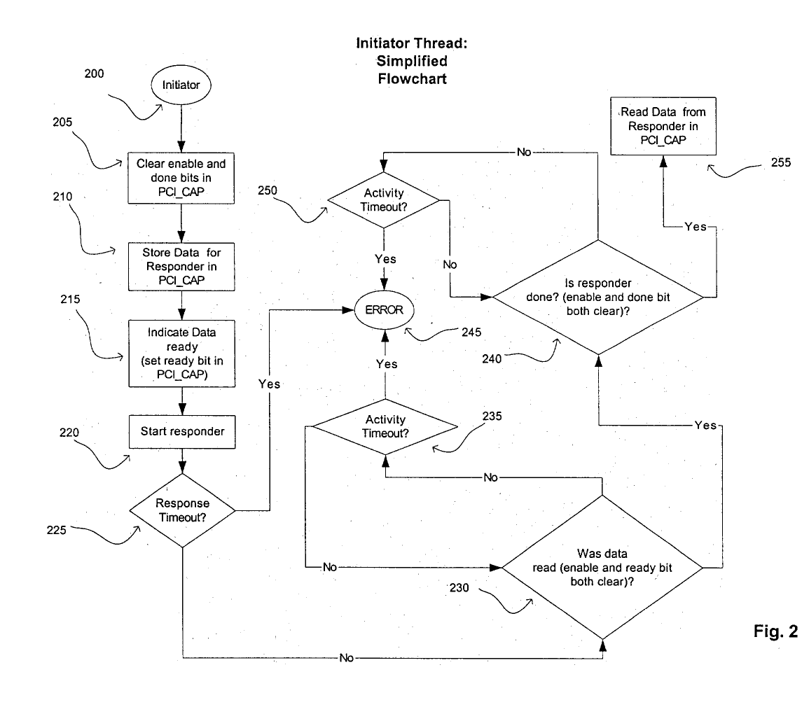

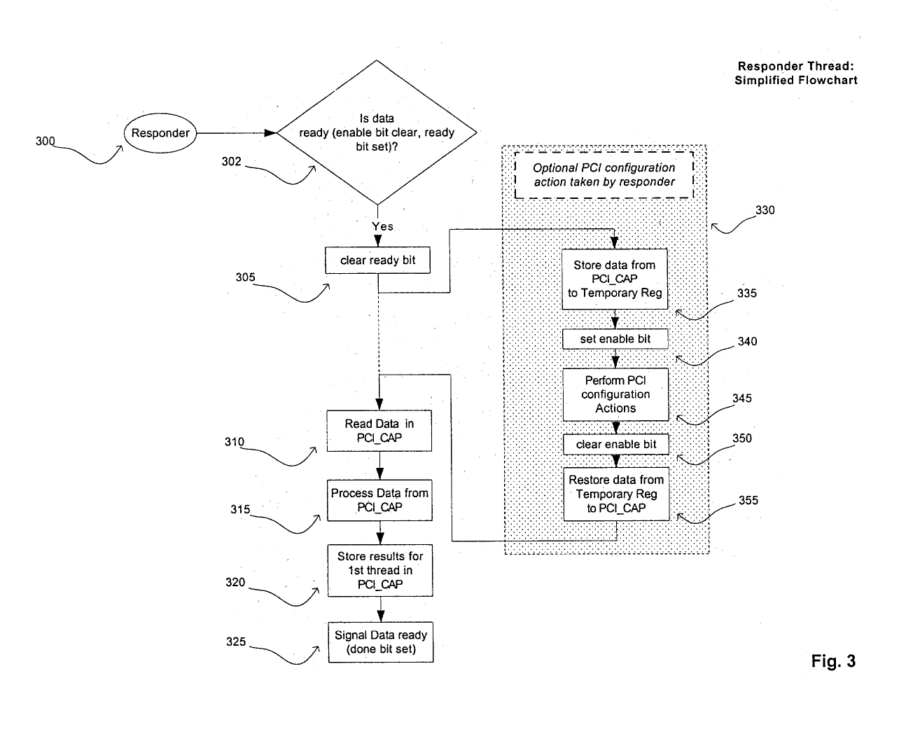

However, the PCI-CAP has no defined purpose when it is loaded with a 32-bit word that is not in compliance with the template, specifically when the enable bit is set to 0. It is by exploiting this situation, that one embodiment of the claimed subject matter performs a data passing method using the PCI-CAP to transfer data between the BSP and an AP by setting the enable bit to 0 and then using the remaining bits of the PCI-CAP as shared memory. In one embodiment of the claimed subject matter, this fact is used to allow data transfers between processors in general to occur by use of the PCI-CAP with the enable bit (bit 31) set to 0. FIGS. 2 and 3 provide a high level flowchart of an algorithm for this purpose that is used in this embodiment of the claimed subject matter.

In this embodiment, the data passing method above takes place when two threads executing concurrently either on the same or on different processors execute in a coordinated fashion. Two bits from the PCI-CAP register are chosen to represent an ready bit and a done bit.

A simplified flowchart depicting this method is shown in FIGS. 2 and 3. The first thread, termed the initiator thread 200 in the flowchart in FIG. 2, first clears the enable bit of the PCI-CAP preventing its use as a configuration register, as in block 205 of the FIG. and clears the done bit that the responding thread will use to signal completion. It then stores data in the PCI-CAP, and sets a ready bit to indicate to the second thread that the data is ready, as depicted in blocks 210 and 215. The initiator thread then starts a second thread, the responder thread, waits for the latter to indicate that it is active (data ready bit and enable bits are both 0), and then waits for the second thread to be done (enable bit and done bit are both 0), with timeout handling (blocks 225-255). FIG. 3 depicts the second thread, termed the responder thread 300. On waking up after basic error checking (302), the thread signals that it is active (clears ready bit in 305). The thread may optionally use the PCI-CAP for configuration addressing, and to do so must save the contents including the data from the first thread, as in block 330 depicting steps 335-355. To use the PCI-CAP in this manner, the second thread first saves any data passed from the initiator in 335, then sets the enable bit to signal that it is starting normal use of the PCI-CAP 340, performs configuration 345, and then restores the data 355 after clearing the enable bit 350. Once the data is processed, the second thread signals the availability of its results in the PCI-CAP by setting the done bit 325. The first thread can then read the results produced by the second (block 255, FIG. 2).

In one embodiment of the claimed subject matter this method is applied to coordinate processor startup and to allow processors to synchronize frequencies. The details of this startup process are part of the subject matter of another patent application by the Applicant and therefore are not disclosed here. U.S. patent application Ser. No.______, Laurance Wygant Coordination of Multiple Multi-Speed Devices, filed Mar. 31, 2003. It will be clear to one skilled in the art, however, that the above data passing method can be used for various types of inter-processor and other inter-device communication tasks in other embodiments.

### Embodiments of the Claimed Subject Matter

Reference throughout this specification to “one embodiment” or “an embodiment” means that a particular feature, structure or characteristic described in connection with the embodiment is included in at least one embodiment of the claimed subject matter. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments

### Implementation of Methods

Embodiments of the claimed subject matter include various steps. These steps may be performed by hardware components, or may be embodied in machine-executable instructions, which may be used to cause a general-purpose or special-purpose processor or logic circuits programmed with the instructions to perform the steps. Alternatively, the steps may be performed by a combination of hardware and software. An embodiment of the claimed subject matter may be provided as a computer program product or as part of the Basic Input/Output System (BIOS) of a computer that may include a machine-readable medium having stored thereon data which when accessed by a machine may cause the machine to perform a process of the claimed subject matter. The machine-readable medium may include, but is not limited to, floppy diskettes, optical disks, DVD-ROM disks, DVD-RAM disks, DVD-RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable medium suitable for storing electronic instructions. Moreover, an embodiment of the claimed subject matter may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claims. It will be apparent to those skilled in the art that many further modifications and adaptations can be made. The particular embodiments of the claimed subject matter are not provided to limit the claims but to illustrate it. The scope of the claims is not to be determined by the specific examples provided above but only by the claims themselves as provided below.

What is claimed is:

1. A method comprising:
a first execution thread disabling configuration access to a register that is otherwise dedicated to a storage of a configuration parameter;
the first execution thread storing data other than the configuration parameter in the register; and
a second execution thread accessing the data from the register.

2. The method of claim 1 further comprising one of the first execution thread and the second execution thread enabling configuration access to the register after the data other than the configuration parameter in the register has been accessed.

3. The method of claim 2 wherein
disabling configuration access to the register further comprises
changing a status indicator to indicate that the register is unavailable for configuration use;
saving the contents of the register; and wherein
enabling configuration access to the register further comprises restoring saved contents, if any, to the register; and
changing the status indicator to indicate that the register is available for configuration use.

4. The method of claim 3 wherein the register is an address register normally dedicated to enabling access to the configuration address space a device on a bus.

5. The method of claim 4 wherein the first execution thread executes on a first processor of a multiprocessor system, and wherein the second execution thread executes on a second processor of the multiprocessor system.

6. The method of claim 4 wherein changing the status indicator to indicate that the register is unavailable for configuration use comprises storing a first value in an enable bit of the register; and wherein changing the status indicator to indicate that the register is available for configuration use comprises storing a second value distinct from the first value in the enable bit of the register.

7. The method of claim 1 further comprising the first execution thread setting a bit of the register to a fixed value after an event occurs and the second execution thread accessing the bit of the register to determine if the event has occurred.

8. A method comprising:
a first execution thread storing data other than a PCI Configuration Address in an address field of a PCI Configuration Address Port; and
a second execution thread reading the data from the address field of the PCI Configuration Address Port.

9. The method of claim 8 wherein the first execution thread executes on a first processor of a multiprocessor system and the second execution thread executes on a second processor of the multiprocessor system.

10. The method of claim 8 further comprising:
the first execution thread clearing the Enable bit of the PCI Configuration Address Port prior to storing the data in the address field of the PCI Configuration Address Port.

11. The method of claim 10 further comprising one of the first execution thread or the second execution thread setting the Enable bit after the data from the address field of the PCI Configuration Address port has been accessed.

12. The method of claim 8 wherein the data is the state of a synchronization flag comprising a bit of the address field of the PCI Configuration Address Port.

13. An apparatus comprising:
a register normally dedicated to store and access a configuration parameter;
an indicator to indicate whether the register is available for configuration use;
a first processor capable of accessing the register, the processor to toggle the indicator to indicate that the register is unavailable for configuration use and
to store data other than the configuration parameter in the register;
a second processor to access data from the register; and
at least one of the first processor and the second processor, to toggle the indicator to indicate that the register is available for configuration use after the data has been accessed.

14. The apparatus of claim 13 wherein
the register is an address register normally dedicated to storage of and access to an address of a device on a bus;
the first processor is a first processor in a multiprocessor system;
the second processor is a second processor in the multiprocessor system;
the indicator comprises a bit of the address register in which is stored either:
a first value to indicate that the register is available for addressing use; or
a second value distinct from the first value to indicate that the register is unavailable for addressing use.

15. An multiprocessor system with a device access bus using an address register with an enable bit comprising:
a first processor to set the enable bit to a first value indicating that the bus is disabled and to store data other than a device address in the address register;
a second processor to access the data from the address register;
at least one of the first processor and the second processor to set the enable bit to a second value distinct from the first value after the data has been accessed to indicate that the bus is enabled.

16. The multiprocessor system of claim 15 wherein the device bus is a Peripheral Component Interconnect (PCI) bus, the address register is the PCI Configuration Address Port and the enable bit is the Enable bit of the PCI Configuration Address Port.

17. A machine-readable medium comprising instructions that when accessed by a machine, cause it to perform the method of claim 1.

18. The machine-readable medium of claim 17 further comprising instructions that when accessed by a machine, cause it to perform the method of claim 2.

19. The machine-readable medium of claim 18 further comprising instructions that when accessed by a machine, cause it to perform the method of claim 3.

20. A machine-readable medium comprising instructions that when accessed by a machine, cause it to perform the method of claim 5.

21. The machine-readable medium of claim 20 further comprising instructions that when accessed by a machine, cause it to perform the method of claim 6.

22. A machine-readable medium comprising instructions that when accessed by a machine, cause it to perform the method of claim 7.

23. A Basic Input/Output System (BIOS) of a computer system with a PCI bus comprising instructions that when executed by the computer system, cause it to perform the method of claim 8.

24. The BIOS of claim 22 further comprising instructions that when executed by the computer system, cause it to perform the method of claim 10.

25. The BIOS of claim 24 further comprising instructions that when executed by the computer system, cause it to perform the method of claim 11.
